(19) United States
(12) Patent Application Publication
(10) Pub. No.: US 2026/0263982 A1
(43) Pub. Date: Sep. 10, 2026

(54) FILTER AND METHOD FOR MANUFACTURING SAME

(71) Applicant: NGK INSULATORS, LTD., Nagoya-City (JP)

(72) Inventor: Shuichi ICHIKAWA, Nagoya-Shi (JP)

(73) Assignee: NGK INSULATORS, LTD., Nagoya-City (JP)

(21) Appl. No.: 19/441,963

(22) Filed: Jan. 7, 2026

(30) Foreign Application Priority Data
Mar. 7, 2025 (JP) 2025-036750

(51) Int. Cl. B01D 46/24; B01D 39/20; B01D 46/00; B01D 46/84; C04B 37/00; C04B 38/00

(52) U.S. Cl. CPC B01D 46/24495; B01D 39/2068; B01D 46/0001; B01D 46/2429; B01D 46/24491; B01D 46/2455; B01D 46/2466; B01D 46/2478; B01D 46/2482; B01D 46/84; C04B 37/003; C04B 38/0019; B01D 2273/18; B01D 2279/30; C04B 2237/083

(57) ABSTRACT

A filter in which side surfaces of a plurality of pillar-shaped honeycomb structure segments made of porous ceramics are joined together via a joining material, wherein each pillar-shaped honeycomb structure segment includes an outer peripheral side wall, and partition walls partitioning a plurality of cells extending from a first end surface to a second end surface; and wherein the joining material is adjusted so that a difference between a flexural strain at flexural strength and a flexural strain at break, as measured by a four-point bending test in accordance with JIS K7017: 1999, as well as a compressive Young's modulus contribute to improving engine durability.

### CROSS REFERENCE TO RELATED APPLICATIONS

The present invention claims the benefit of priority to Japanese Patent Application No. 2025-36750 filed on Mar. 7, 2025 with the Japanese Patent Office, the entire contents of which are incorporated herein by reference in its entirety.

### FIELD OF THE INVENTION

The present invention is related to a filter having a structure in which side surfaces of a plurality of pillar-shaped honeycomb structure segments made of porous ceramics are joined together via a joining material. Further, the present invention is related to a method for manufacturing such a filter.

### BACKGROUND OF THE INVENTION

Particulate matter (hereinafter referred to as PM) in exhaust gas discharged from internal combustion engines such as diesel engines and gasoline engines contains soot. Soot is harmful to the human body, so its emission is regulated. Currently, in order to comply with exhaust gas regulations, filters with a pillar-shaped honeycomb structure, such as DPFs and GPFs, are widely used, which filter out soot and other PM by passing exhaust gas through porous ceramic partitions.

In order to continue using such a filter for a long period of time, the filter needs to be regenerated. That is, in order to eliminate the increase in pressure loss caused by PM that accumulates inside the filter over time, it is necessary to remove the PM that has accumulated inside the filter by burning it. During the regeneration of the filter, a large thermal stress is generated, which causes defects such as cracks and breaks in the filter.

In response to the demand for improved thermal shock resistance against such thermal stress, a filter has been proposed that has a segment structure in which side surfaces of a plurality of pillar-shaped honeycomb structure segments are joined together with a joining material to form a segment joint body that has the function of dispersing and mitigating thermal stress, and attempts also have been made to further improve its thermal shock resistance.

However, in recent years, there has been an increasing demand for larger filters, which leads to increased thermal stress during regeneration. In order to prevent the above-mentioned defects, there is a strong demand for improved thermal shock resistance. In particular, it is desirable for the joining material for integrally joining a plurality of pillar-shaped honeycomb structure segments to have excellent stress relaxation function and joining strength, thereby realizing a filter with excellent thermal shock resistance.

Patent Literature 1 proposes a honeycomb structure, in which the porosity of an outer portion located from the interface of the joining material layer with the joining surface of the honeycomb segment to a position away by a length equivalent to 20% of the entire layer thickness is smaller than the porosity of a central portion located inward from the outer portion, and the compressive Young's modulus of the joining material layer in the Z-axis direction is 5 to 100 (MPa).

Patent Literature 2 proposes a honeycomb structure, in which the joining material contains 20% by mass or less of crystalline anisotropic ceramic particles and a granular pore-forming agent having an average particle size in the joining material of 80 to 200 μm, and assuming a compressive Young's modulus of the joining material is E (unit: MPa) and a shear strength of the joining material is σ (unit: kPa), σ/E satisfies 5 to 50, and the crystalline anisotropic ceramic particles have a needle-like shape as their primary particles.

### PRIOR ART

### Patent Literature

[Patent Literature 1] Japanese Patent No. 5103378
[Patent Literature 2] Japanese Patent No. 6077484

### SUMMARY OF THE INVENTION

Controlling the compressive Young's modulus of the joining material or the relationship between the compressive Young's modulus of the joining material and the shear strength of the joining material is useful for the engine durability of the filter. However, taking into consideration the fact that filters will be used in harsher environments due to factors such as an increase in the amount of soot deposition per volume associated with the downsizing of engines, a rise in regeneration temperature due to increased porosity of partition walls in light of an increase in the amount of catalyst applied, and an increase in thermal stress caused by larger filters for installation in large vehicles, there is a demand for filters to have even greater engine durability.

In view of the above circumstances, an object of the present invention in one embodiment is to provide a filter in which side surfaces of a plurality of pillar-shaped honeycomb structure segments made of porous ceramics are joined together via a joining material, which contributes to improving engine durability. Further, an object of the present invention in another embodiment is to provide a method for manufacturing such a filter.

The inventors have conducted intensive research to solve the above problems and discovered that the engine durability of the filter can be significantly improved by controlling not only the compressive Young's modulus of the joining material used to join the sides of the pillar-shaped honeycomb structure segments, but also the difference between the flexural strain at flexural strength and the flexural strain at break. The present invention has been completed based on this finding, and is exemplified as below.

### [Aspect 1]

A filter in which side surfaces of a plurality of pillar-shaped honeycomb structure segments made of porous ceramics are joined together via a joining material, wherein each of the pillar-shaped honeycomb structure segments comprises an outer peripheral side wall, and partition walls partitioning a plurality of cells extending from a first end surface to a second end surface; and wherein the joining material is adjusted such that a difference between a flexural strain at flexural strength and a flexural strain at break, as measured by a four-point bending test in accordance with JIS K7017: 1999, as well as a compressive Young's modulus contribute to improving engine durability.

### [Aspect 2]

A filter in which side surfaces of a plurality of pillar-shaped honeycomb structure segments made of porous ceramics are joined together via a joining material, wherein each of the pillar-shaped honeycomb structure segments comprises an outer peripheral side wall, and partition walls partitioning a plurality of cells extending from a first end surface to a second end surface; and wherein the joining material has a difference between a flexural strain at flexural strength and a flexural strain at break of 0.002 to 0.007, as measured by a four-point bending test in accordance with JIS K7017: 1999, and a compressive Young's modulus of 5 to 100 MPa.

### [Aspect 3]

The filter according to aspect 1 or 2, wherein the joining material has the difference between the flexural strain at flexural strength and the flexural strain at break of 0.0035 to 0.006, and the compressive Young's modulus of 20 to 60 MPa.

### [Aspect 4]

The filter according to any one of aspects 1 to 3, wherein a shear strength between the side surfaces of the plurality of pillar-shaped honeycomb structure segments and the joining material is 600 kPa or more.

### [Aspect 5]

The filter according to any one of aspects 1 to 4, wherein the joining material has a porosity of 40% or more.

### [Aspect 6]

The filter according to any one of aspects 1 to 5, wherein the joining material comprises silicon carbide.

### [Aspect 7]

The filter according to any one of aspects 1 to 6, wherein a length of the plurality of pillar-shaped honeycomb structure segments in a direction in which the cells extend is 178 mm or more.

### [Aspect 8]

The filter according to any one of aspects 1 to 7, wherein when a step of heating the filter in an electric furnace at a set temperature for 2 hours, removing the filter from the electric furnace, and allowing the filter to cool to room temperature, and then visually checking whether or not any cracks having a length of 3 mm or more are observed in the filter, is repeated under a condition that an initial temperature is set to 250° C. and the set temperature is increased by 50° C. each time until any cracks are observed, the set temperature at which any cracks are observed is 350° C. or higher.

### [Aspect 9]

The filter according to any one of aspects 1 to 8, wherein when the following steps 1 to 5 are performed, a maximum temperature in the step 3 when any cracks having a length of 3 mm or more are observed in the filter is 1000° C. or higher:
step 1: a non-thermally expandable mat of mullite fiber is wound around the outer periphery of the filter, and the filter is then pressed into a stainless steel can body at a pressure in a range of 0.1 to 0.5 MPa to form a canned structure, and a combustion gas containing soot generated by burning diesel fuel with a burner is then allowed to flow into the cells from the first end surface of the filter and to flow out from the second end surface, thereby depositing 3 g/L of soot in the filter;
step 2: after the step 1, the filter is allowed to cool to room temperature;
step 3: after the step 2, the maximum temperature at a point 15 mm inward from the second end surface is measured when a high-temperature gas of 650° C. is introduced from the first end surface of the filter at 3 Nm³/min to combust the soot in the filter;
step 4: after the step 3, the filter is again allowed to cool to room temperature, and visually checked whether or not any cracks having the length of 3 mm or more are observed;
step 5: if it is confirmed in the step 4 that no cracks are observed, steps 1 to 4 are repeated under a condition that an amount of soot deposited in the filter in the step 1 is increased by 0.5 to 1 g/L.

### [Aspect 10]

A method for manufacturing a filter, comprising:
a step 1 of preparing a plurality of pillar-shaped honeycomb structure segments made of porous ceramics, each comprising an outer peripheral side wall, and partition walls partitioning a plurality of cells extending from a first end surface to a second end surface; and
a step 2 of joining side surfaces of the plurality of pillar-shaped honeycomb structure segments made of porous ceramics together using a slurry for joining and then drying the slurry for joining;
wherein the slurry for joining comprises:
an anisotropic inorganic powder having an aspect ratio of 15 or more, an average minor axis of 2 to 10 μm, and an average major axis of 30 to 250 μm, in an amount of 5 to 25% by mass with respect to a solid content of the slurry for joining,
a fine aggregate having an aspect ratio of 5 or less and an average diameter of 10 μm or less, in an amount of 40 to 60% by mass with respect to the solid content of the slurry for joining,
a coarse aggregate having an aspect ratio of 5 or less and an average diameter of 30 μm or more, in an amount of 5 to 15% by mass with respect to the solid content of the slurry for joining, and
a pore-forming agent having an average diameter of 30 to 120 μm, in an amount of 1 to 7% by mass with respect to the solid content of the slurry for joining.

### [Aspect 11]

The method for manufacturing a filter according to aspect 10, wherein a mass ratio of the fine aggregate to the coarse aggregate in the slurry for joining is 4 to 10.

### [Aspect 12]

The method for manufacturing a filter according to aspect 10 or 11, wherein a ratio of the average diameter of the coarse aggregate to the average diameter of the fine aggregate in the slurry for joining is in a range of 10 to 100.

### [Aspect 13]

The method for manufacturing a filter according to any one of aspects 10 to 12, wherein each particle constituting the anisotropic inorganic powder has a fibrous and/or plate-like shape.

### [Aspect 14]

The method for manufacturing a filter according to any one of aspects 10 to 13, wherein the anisotropic inorganic powder comprises ceramic fibers having the aspect ratio of 15 or more, the average minor axis of 2 to 10 μm, and the average major axis of 100 to 250 μm.

### [Aspect 15]

The method for manufacturing a filter according to aspect 14, wherein a content of the ceramic fibers is 5 to 25% by mass with respect to the solid content of the slurry for joining.

### [Aspect 16]

The method for manufacturing a filter according to any one of aspects 10 to 15, wherein the fine aggregate contains silicon carbide.

### [Aspect 17]

The method for manufacturing a filter according to any one of aspects 10 to 16, wherein the coarse aggregate comprises cordierite.

According to the filter in one embodiment of the present invention, a remarkable effect is obtained in that the engine durability can be significantly improved without changing the design of the honeycomb structure segments itself.

### BRIEF DESCRIPTION OF THE DRAWINGS

FIG. 1A is a schematic bottom view of a filter according to one embodiment of the present invention.

FIG. 1B is a schematic side view of a filter according to one embodiment of the present invention.

FIG. 2 is a schematic perspective view of a pillar-shaped honeycomb structure segment constituting a filter according to one embodiment of the present invention is shown.

FIG. 3 is a schematic cross-sectional view of a pillar-shaped honeycomb structure segment constituting a filter according to one embodiment of the present invention, observed from a cross section parallel to the direction in which the cells extend.

FIG. 4 is a schematic diagram for explaining the structure of a test piece and the direction of load when performing a bending test.

FIG. 5 is a schematic diagram for explaining the structure of a test piece and the direction of load when measuring the compressive Young's modulus.

FIG. 6 is a schematic diagram for explaining the structure of a segment joint body and the direction of load when measuring shear strength.

### DETAILED DESCRIPTION OF THE INVENTION

Hereinafter, embodiments of the present invention will now be described in detail with reference to the drawings. It should be understood that the present invention is not intended to be limited to the following embodiments, and any change, improvement or the like of the design may be appropriately added based on ordinary knowledge of those skilled in the art without departing from the spirit of the present invention.

### (1. Filter)

The filter according to the present invention can be used, for example, as a DPF (Diesel Particulate Filter) or GPF (Gasoline Particulate Filter) that is attached to an exhaust gas line from a combustion device, typically an engine mounted on a vehicle, for collecting soot. The filter according to the present invention can be installed, for example, in an exhaust pipe, and a cushioning mat can be interposed between the inner surface of the exhaust pipe and the filter to hold the filter in the exhaust pipe.

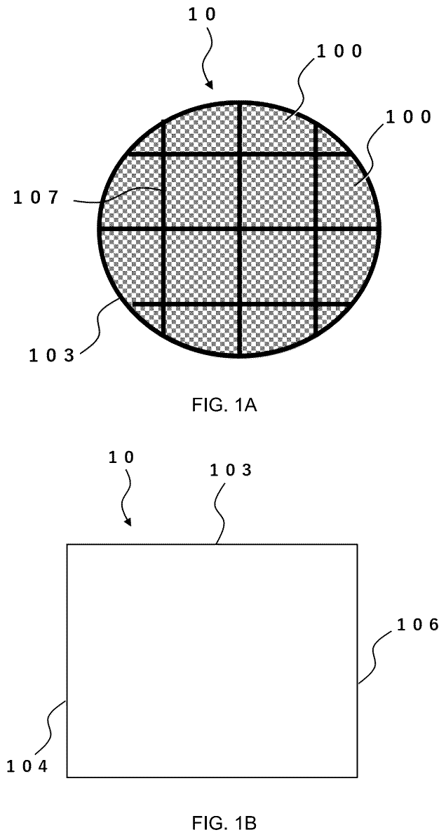

FIG. 1A shows a schematic bottom view of a filter 10 according to one embodiment of the present invention. FIG. 1B shows a schematic side view of a filter 10 according to one embodiment of the present invention. The filter 10 comprises a first end surface 104 which serves as an inlet for the exhaust gas, and a second end surface 106 which serves as an outlet for the exhaust gas. The exhaust gas flowing in from the first end surface 104 is purified while passing through the filter 10 and is discharged from the second end surface 106. The filter 10 has a structure in which the side surfaces 102 of a plurality of pillar-shaped honeycomb structure segments 100 are joined together via a joining material 107. By joining a plurality of pillar-shaped honeycomb structure segments 100 together to provide a segment joint body, it is possible to improve the thermal shock resistance. In addition, the filter 10 can have an outer peripheral wall 103 that is formed by grinding the outer peripheral portion into a desired shape (for example, cylindrical shape), applying a coating material to the outer peripheral side surface, and then drying and heat treating the coating material.

### (2. Pillar-Shaped Honeycomb Structure Segment)

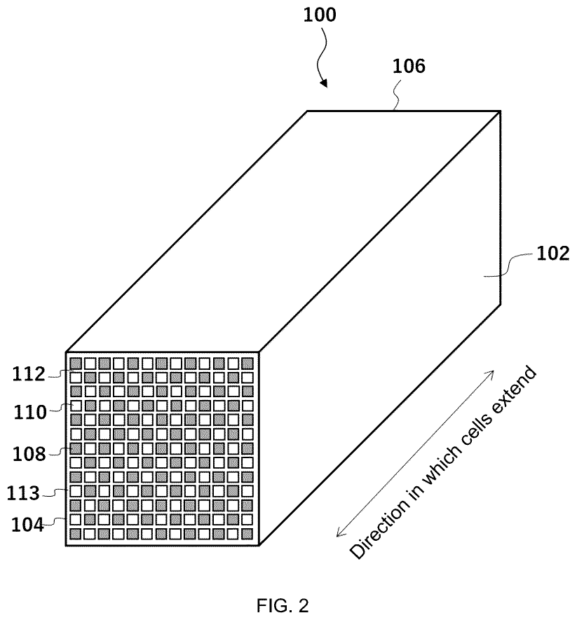

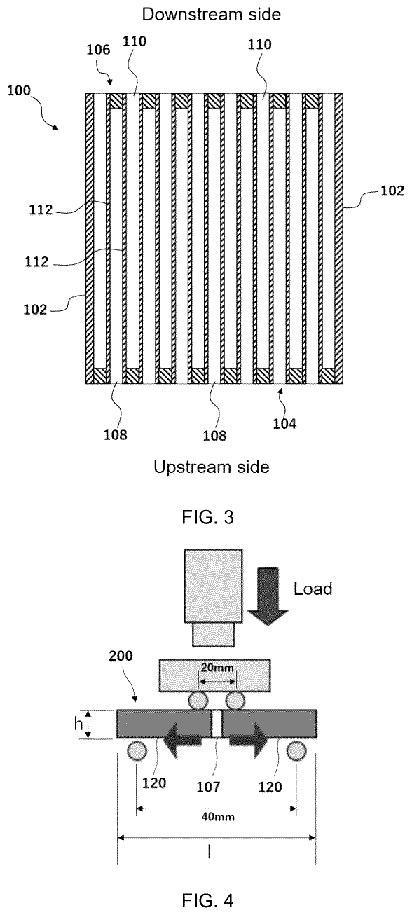

FIG. 2 is a schematic perspective view of a pillar-shaped honeycomb structure segment 100 constituting a filter according to an embodiment of the present invention. FIG. 3 shows a schematic cross-sectional view of a pillar-shaped honeycomb structure segment 100 constituting a filter according to one embodiment of the present invention, observed in a cross section parallel to the direction in which the cells extend.

The pillar-shaped honeycomb structure segment 100 comprises a honeycomb structure having an outer peripheral side wall 113 with a side surface 102, and porous partition walls 112 arranged inside the outer peripheral side wall 113 and partitioning a plurality of cells 108, 110 extending from the first end surface 104 to the second end surface 106. Each cell 108, 110 may pierce from the first end surface 104 to the second end surface 106 with both the first end surface 104 and the second end surface 106 being open. However, in order to improve PM collection performance, it is preferable that the pillar-shaped honeycomb structure segment 100 have a plurality of first cells 108 extending from the first end surface 104 to the second end surface 106, the first end surface 104 being open and the second end surface 106 being sealed, and a plurality of second cells 110 adjacent to at least one of the first cells 108, extending from the first end surface 104 to the second end surface 106, the first end surface 104 being sealed and the second end surface 106 being open. In this case, the pillar-shaped honeycomb structure segment 100 can have the first cells 108 and the second cells 110 arranged alternately and adjacently with partition walls 112 interposed therebetween such that both end surfaces have a checkered pattern.

When exhaust gas containing soot is supplied to the first end surface 104 on the upstream side of the pillar-shaped honeycomb structure segment 100, the exhaust gas is introduced into the first cells 108 and travels downstream in the first cells 108. Since the first cells 108 are sealed at the second end surface 106 on the downstream side, the exhaust gas passes through the porous partition walls 112 that partition the first cells 108 and the second cells 110 and flows into the second cells 110. Since the soot cannot permeate through the partition walls 112, it is collected and accumulated in the first cells 108. After the soot is removed, the clean exhaust gas that has flowed into the second cells 110 advances downstream in the second cells 110 and flows out from the second end surface 106 on the downstream side.

The outer shape of the pillar-shaped honeycomb structure segment 100 is not particularly limited as long as it is pillar-shaped. For example, it may be pillar-shaped with polygonal end surfaces. Examples of polygons include quadrangles (rectangles, squares, and the like) and hexagons. In a typical embodiment, the outer shape of the pillar-shaped honeycomb structure segment 100 may be a quadrangular pillar shape. The size of the pillar-shaped honeycomb structure segment 100 may be, for example, 600 to 3600 mm², typically 900 to 2500 mm² for an end surface area. The length (height) of the pillar-shaped honeycomb structure segment 100 in the direction in which the cells extend can be, for example, 60 to 500 mm, and typically 100 to 400 mm. Among the above length range, from the viewpoint that the effect of improving engine durability is more likely to become apparent, it is preferable that the length of the pillar-shaped honeycomb structure segment 100 in the direction in which the cells extend be 178 mm or more, more preferably 203 mm or more, and even more preferably 254 mm or more.

There are no limitations on the shape of the cells in a cross section orthogonal to the direction in which the first cells 108 and the second cells 110 extend (the height direction), but a quadrangle, hexagon, octagon, or a combination thereof is preferable. Among these, quadrangle and hexagonal shapes are preferable. By configuring the cell shape in this way, when the pillar-shaped honeycomb structure segment 100 is used as a particulate filter, the pressure loss when exhaust gas flows through it is small, and the purification performance is excellent.

The material of the pillar-shaped honeycomb structure segment 100 is not limited to, but may be, for example, porous ceramics. As the ceramics, mention can be made to cordierite, mullite, zirconium phosphate, aluminum titanate, silicon carbide, silicon-silicon carbide composites (for example, Si-bonded SiC), cordierite-silicon carbide composites, zirconia, spinel, indialite, sapphirine, corundum, titania, and silicon nitride. In addition, as the ceramics, one type can be contained alone, or two or more types may be contained in combination. Other materials for the pillar-shaped honeycomb structure segment 100 include porous sintered metals containing alloy components whose main components are one or more elements selected from the group consisting of Fe, Cr, Mo, and Ni.

The average thickness of the partition walls 112 in each pillar-shaped honeycomb structure segment 100 is not particularly limited, but is preferably 0.1 mm to 0.5 mm. By setting the average thickness of the partition walls 112 to be preferably 0.1 mm or more, and more preferably 0.2 mm or more, the strength of each pillar-shaped honeycomb structure segment 100 can be ensured. Further, by setting the average thickness of the partition walls 112 to preferably 0.5 mm or less, more preferably 0.4 mm or less, the pressure loss when exhaust gas is caused to flow through each pillar-shaped honeycomb structure segment 100 can be kept low.

As used herein, the thickness of the partition wall refers to a crossing length of a line segment that crosses the partition wall when the centers of gravity of adjacent cells are connected by this line segment in a cross-section orthogonal to the direction in which the cells extend. The average thickness of the partition walls refers to the average value of the thicknesses of all the partition walls in each pillar-shaped honeycomb structure segment.

The cell density of the pillar-shaped honeycomb structure segment is preferably 50 to 400 cells/inch² (7.7 to 62.0 cells/cm²), more preferably 70 to 370 cells/inch² (10.8 to 57.3 cells/cm²), and even more preferably 80 to 320 cells/inch² (12.4 to 49.6 cells/cm²). If the cell density of the pillar-shaped honeycomb structure segment is less than 50 cells/in² (7.7 cells/cm²), sufficient strength may not be obtained. On the other hand, if the cell density of the pillar-shaped honeycomb structure segment exceeds 400 cells/in² (62.0 cells/cm²), the pressure loss becomes too high, which may result in a decrease in engine output when used as a DPF. As used herein, the cell density is a value obtained by dividing the number of cells by the area (the total area of the partition walls and cells excluding the outer peripheral side wall) of one of the end faces (the first end face or the second end face) of the pillar-shaped honeycomb structure segment.

In each pillar-shaped honeycomb structure segment, the porosity of the partition walls 112 can be, for example, 30% to 80%, and preferably 40% to 70%. By setting the porosity of the partition walls within the above range, there is an advantage that the strength of the manufactured pillar-shaped honeycomb structure segment can be maintained while the pressure loss can be suppressed. On the other hand, if the porosity is lower than 30%, a problem of increased pressure loss occurs, and if the porosity exceeds 80%, there are effects such as a decrease in strength and a decrease in thermal conductivity. Here, the porosity of the partition walls is an average value obtained by collecting a plurality of partition wall samples from the pillar-shaped honeycomb structure segment without bias and measuring the porosity of each sample by mercury porosimetry. Specifically, the porosity is calculated from the total pore volume (unit: cm³/g) by mercury porosimetry (in accordance with JIS R1655: 2003) and the apparent density (unit: g/cm³) by the underwater Archimedes method.

In addition, the average pore diameter of the partition walls of each pillar-shaped honeycomb structure segment is not limited, but from the perspective of the balance among ease of catalyst support, PM collection efficiency, and strength, it is preferably 7 μm to 40 μm, more preferably 7 μm to 30 μm, and even more preferably 7 μm to 23 μm. Here, the average pore diameter of the partition walls is an average value obtained by collecting a plurality of partition wall samples from the pillar-shaped honeycomb structure segment without bias and measuring the average pore diameter of each sample by mercury porosimetry.

In each pillar-shaped honeycomb structure segment, the average thickness of the outer peripheral side wall 113 is not limited, but considering the balance between the strength and filter performance of the pillar-shaped honeycomb structure segment 100, it can be, for example, 0.1 mm to 0.5 mm, and 0.15 mm to 0.4 mm is preferable. As used herein, the average thickness of the outer peripheral side wall refers to an average value obtained by measuring the thicknesses of a plurality of points of the outer peripheral side wall without bias in a cross section orthogonal to the direction in which the cells extend.

### (3. Joining Material)

The joining material 107 serves to join the side surfaces 102 of the pillar-shaped honeycomb structure segments 100 together. In one embodiment, the joining material 107 is interposed in the form of a layer between the side surfaces 102 of the pillar-shaped honeycomb structure segments 100 facing each other. The thickness of the joining material 107 (the length in the direction perpendicular to the joining surface of the joining material with the pillar-shaped honeycomb structure segment) is set taking into account the joining force (shear strength) between the pillar-shaped honeycomb structure segments 100, and is appropriately selected, for example, in the range of 0.5 to 3.0 mm.

In one embodiment, the joining material 107 is controlled such that the difference between the flexural strain at flexural strength and the flexural strain at break, measured by a four-point bending test in accordance with JIS K7017: 1999, as well as the compressive Young's modulus contribute to improving engine durability. For example, the difference between the flexural strain at flexural strength and the flexural strain at break, measured by a four-point bending test in accordance with JIS K7017: 1999, is 0.002 to 0.007, and the compressive Young's modulus is 5 to 100 MPa. This provides an excellent thermal stress relaxation mechanism and also provides the effect of making it difficult for cracks to grow even if they occur, thereby making it possible to improve the thermal shock resistance of the filter 10.

In the four-point bending test, a test piece 200 of 80 mm (I)×15 mm (b)×10 mm (h) is taken from the filter. The test piece is prepared using a four-point bending apparatus as specified in JIS K7017: 1999, as shown in FIG. 4, with the distance between the outer supports being 40 mm and the distance between the inner supports being 20 mm, such that the joining material 107 is positioned at the center of the length of the test piece, with the portion 120 of the pillar-shaped honeycomb structure segment positioned on both sides thereof.

The larger the difference between the flexural strain at flexural strength and the flexural strain at break (εfB-εfM) is, the more durable the joining material is, and the less likely it is to break even if the strain increases beyond the yield point. On the other hand, if εfB-εfM is too large, the degree of deformation of the joining material becomes too large, and there is a concern that a large stress will be applied to the pillar-shaped honeycomb structure segments joined via the joining material. In this case, the inherent function of the joining material, that is, stress relaxation to prevent damage to the pillar-shaped honeycomb structure segments, is lost, which is not preferable. Therefore, εfB-εfM is preferably 0.002 to 0.007, more preferably 0.0035 to 0.006, and even more preferably 0.004 to 0.006.

As used herein, the difference between the flexural strain at flexural strength and the flexural strain at break of the joining material (εfB-εfM) refers to the average value obtained by measuring εfB-εfM for each of five test pieces taken without bias from the filter.

The flexural strain is calculated according to the following formula (1).

$$ε f = \frac{4.7 Sh}{{L}^{2}} \qquad ( 1 )$$

$$in which ,$$

$$ε f : Flexural strain$$

$$S : Deflection at the center point ( mm )$$

$$h : Thickness of test piece ( mm )$$

$$L : Distance between supports ( mm )$$

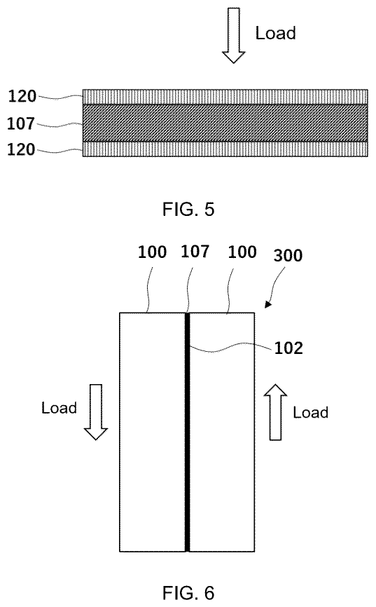

The compressive Young's modulus means the Young's modulus when compressed in the thickness direction of the joining material (the direction perpendicular to the joining surface of the joining material with the pillar-shaped honeycomb structure segment), and is measured by the following procedure. First, a test piece having a predetermined size (planar dimension of 10 mm×10 mm to 30 mm×30 mm, thickness of 0.5 to 3 mm) is cut out, and then is subjected to a compression test. In this test, the test piece does not need to be composed of only the joining material, and may have the portion 120 of the pillar-shaped honeycomb structure segment attached. This is because the strength of the pillar-shaped honeycomb structure segment is much greater than that of the joining material. In this case, however, the test piece should have a sandwich structure in which the upper and lower surfaces of the joining material 107 are sandwiched between portions 120 of a pair of pillar-shaped honeycomb structure segments as shown in FIG. 5. The slope of the stress-strain curve when a pressure of 0 to 3 MPa is applied to the test piece in the compression direction is taken as the compressive Young's modulus and is calculated according to the following formula (2).

$$E = ( W / S ) \times ( t / Δ t ) \qquad ( 2 )$$

$$E : Compressive Young ’ s modulus ( MPa )$$

$$W : Load ( N )$$

$$S : Test piece area ( {mm}^{2} )$$

$$t : Test piece thickness ( mm )$$

$$Δ t : Change in test piece thickness$$

A lower compressive Young's modulus improves the flexibility of the joining material and provides a high stress relaxation effect. However, if the modulus is too low, the joining material will deform to an excessively large extent, which may result in a large stress being applied to the pillar-shaped honeycomb structure segments joined via the joining material. Therefore, the compressive Young's modulus of the joining material is preferably 5 to 100 MPa, more preferably 20 to 60 MPa, and even more preferably 30 to 50 MPa.

In the present invention, the compressive Young's modulus of the joining material refers to the average value of the compressive Young's modulus measured for a plurality of test pieces taken without bias from the filter.

In a preferred embodiment, the joining material has a difference between the flexural strain at flexural strength and the flexural strain at break of 0.0035 to 0.006, and a compressive Young's modulus of 20 to 60 MPa. In a more preferred embodiment, the joining material has a difference between the flexural strain at flexural strength and the flexural strain at break of 0.004 to 0.006, and a compressive Young's modulus of 30 to 50 MPa.

In addition, in order to ensure the strength of the filter, it is preferable that the shear strength between the side surface 102 of the pillar-shaped honeycomb structure segment 100 and the joining material 107 is high. Specifically, the shear strength is preferably 600 kPa or more, more preferably 800 kPa or more, and even more preferably 1000 kPa or more. However, if the shear strength is too high, there is a tendency that it will not be possible to alleviate thermal stress, and therefore the shear strength is preferably 2000 kPa or less, more preferably 1700 kPa or less, and even more preferably 1400 kPa or less. Therefore, the shear strength is, for example, preferably 600 to 2000 kPa, more preferably 800 to 1700 kPa, and even more preferably 1000 to 1400 kPa.

The shear strength between the side surface 102 of the pillar-shaped honeycomb structure segment 100 and the joining material 107 is measured by the following procedure. First, a segment joint body 300 having a pair of pillar-shaped honeycomb structure segments 100 joined to each other is cut out from the filter 10 (see FIG. 6). A shear load is then applied in the direction in which the first cells 108 and the second cells 110 of this segment joint body 300 extend. Then, the shear strength is calculated using the fracture load and the area of the joint surface of the joint material according to the following formula (3).

$$σ = ( W / S ) \times 1000 \qquad ( 3 )$$

$$σ : Shear strength ( kPa )$$

$$W : Fracture load ( N )$$

$$S : Area of the joining surface of the joining material ( mm 2 )$$

As used herein, the shear strength refers to the average value when a plurality of segment joint bodies is collected from a filter without bias and the shear strength of each of the segment joint bodies is measured.

In one embodiment, the joining material 107 is porous. When the joining material 107 is porous, there is a tendency that the compressive Young's modulus decreases as the porosity increases, and conversely, the compressive Young's modulus increases as the porosity decreases. From the viewpoint of obtaining the above-mentioned compressive Young's modulus, the porosity of the joining material is preferably 40% or more, more preferably 50% or more, and even more preferably 60% or more. However, from the viewpoint of ensuring the joining strength, the porosity of the joining material is preferably 80% or less, more preferably 75% or less, and even more preferably 70% or less. Therefore, the porosity of the joining material is, for example, preferably 40 to 80%, more preferably 50 to 75%, and even more preferably 60 to 70%.

The porosity of the joining material is calculated by taking a plurality of samples of the joining material from the filter without bias, and calculating the total pore volume (unit: cm³/g) by mercury porosimetry (in accordance with JIS R1655: 2003) and the apparent density (unit: g/cm³) by the underwater Archimedes method. That is, the porosity here is the porosity before catalyst is carried.

The joining material may contain one or more of ceramics or other inorganic substances, such as cordierite, mullite, alumina, silica, alumina silicate, volastonite, mica, zirconium phosphate, aluminum titanate, silicon carbide, silicon-silicon carbide composites (for example, Si-bonded SiC), cordierite-silicon carbide composites, zirconia, spinel, indialite, sapphirine, corundum, titania, and silicon nitride.

When an electric furnace spalling (E-sp) test is performed on the filter according to one embodiment of the present invention under the following conditions, the set temperature at which any cracks can be observed is 350° C. or higher, preferably 400° C. or higher, and typically 350° C. to 450° C. The electric furnace spalling test is a test in which the filter is heated in an electric furnace at a set temperature for 2 hours, then removed from the electric furnace and allowed to cool to room temperature, and then the filter is visually checked whether or not any cracks having a length of 3 mm or more are observed in the filter. This step is repeated under a condition that an initial temperature is set to 250° C. and the set temperature is increased by 50° C. each time until any cracks are observed, so that the set temperature at which any cracks are observed is determined.

According to an embodiment of the present invention, when a Soot Mass Limit test (SML test) is performed on a filter under the following conditions, the maximum temperature of soot combustion at which any cracks occur in the filter is 1000° C. or higher, preferably 1100° C. or higher, and typically 1200° C. to 1400° C. The Soot Mass Limit test is a test in which the following steps 1 to 5 are performed. Step 1: a non-thermally expandable mat of a mullite composition fiber is wound around the outer periphery of the filter, and the filter is then pressed into a stainless steel can body at a pressure in the range of 0.1 to 0.5 MPa to form a canned structure. Then, a soot-containing combustion gas generated by burning diesel fuel with a burner is caused to flow into the cells from the first end surface of the filter and to flow out from the second end surface, thereby depositing 3 g/L of soot in the filter. Step 2: after the step 1, the filter is allowed to cool to room temperature. Step 3: after the step 2, the maximum temperature at a point 15 mm inward from the second end surface is measured when a high-temperature gas of 650° C. is introduced from the first end surface of the filter at 3 Nm³/min to combust the soot in the filter. Step 4: after the step 3, the filter is again allowed to cool to room temperature, and visually checked whether or not any cracks having the length of 3 mm or more are observed in the filter. Step 5: if it is confirmed in the step 4 that no cracks are observed, steps 1 to 4 are repeated under a condition that an amount of soot deposited in the filter in the step 1 is increased by 0.5 to 1 g/L. Consequently, the maximum temperature in the step 3 when any cracks are observed in the filter is measured. In addition, the mullite composition refers to a compound of aluminum oxide and silicon dioxide in which the molar ratio (Al₂O₃:SiO₂) is in the range of 67:33 to 60:40.

### (4. Method for Manufacturing Filter)

In a first embodiment according to the present invention, a method for manufacturing a filter comprises:
a step 1 of preparing a plurality of pillar-shaped honeycomb structure segments made of porous ceramics, each comprising an outer peripheral side wall, and partition walls partitioning a plurality of cells extending from a first end surface to a second end surface; and
a step 2 of joining side surfaces of the plurality of pillar-shaped honeycomb structure segments made of porous ceramics together using a slurry for joining and then drying the slurry for joining.

In the step 1, a plurality of pillar-shaped honeycomb structure segments made of porous ceramics, each comprising an outer peripheral side wall, and partition walls partitioning a plurality of cells extending from a first end surface to a second end surface is prepared. The pillar-shaped honeycomb structure segment made of porous ceramics can be manufactured in accordance with a known method for manufacturing a honeycomb structure, and an example of the procedure will be described below. First, a green body containing predetermined ceramic raw materials, a dispersion medium, a pore-forming agent, and a binder is prepared. Next, the green body is extrusion molded to prepare a honeycomb formed body. In the extrusion molding, a die having a desired overall shape, cell shape, partition wall thickness, cell density, and the like can be used. When sealing the end surfaces of the honeycomb formed body, the method is not particularly limited, and a well-known method can be used, in which end surface covered with a dedicated mask and the cell openings are filled with a slurry for sealing. After that, the dried honeycomb formed body is fired so that a pillar-shaped honeycomb structure segment can be prepared. The firing conditions may be any known conditions depending on the material of the segment, and are not particularly limited.

In the step 2, side surfaces of a plurality of pillar-shaped honeycomb structure segments made of porous ceramics are joined together using a slurry for joining, and the slurry for joining is then dried. This converts the slurry for joining into a joining material, and a segment joint body is prepared. Specifically, a segment joint body can be prepared by the following procedure. With a film for preventing adhesion of the joining material attached to both end surfaces of each pillar-shaped honeycomb structure segment, the joining material is applied to the joining surfaces (side surfaces). Next, these segments are arranged adjacent to each other so that their side surfaces face each other, and the adjacent segments are pressed together, and then heated and dried. In this manner, a segment joint body is prepared in which the side surfaces of adjacent segments are joined together by the joining material. In addition, the properties of the joining material may further change during heat treatment of the outer peripheral wall, which will be described later.

The material of the film for preventing adhesion of the joining material is not particularly limited, but for example, synthetic resins such as polypropylene (PP), polyethylene terephthalate (PET), polyimide, or Teflon (registered trademark) can be suitably used. In addition, the film preferably has an adhesive layer, and the material of the adhesive layer is preferably an acrylic resin, a rubber resin (for example, a rubber whose main component is natural rubber or synthetic rubber), or a silicone resin.

The slurry for joining can be prepared by mixing, for example, anisotropic inorganic powder, aggregate, pore-forming agent, dispersion medium (for example water or the like), and, if necessary, additives such as binders and dispersants.

Regarding the joining material, in order to ensure that the difference between the flexural strain at flexural strength and the flexural strain at break, the compressive Young's modulus, the shear strength, and the porosity satisfy the above-mentioned conditions, it is necessary to pay particular attention to the selection of the anisotropic inorganic powder, aggregate, and pore-forming agent.

In one embodiment, the slurry for joining comprises:
an anisotropic inorganic powder having an aspect ratio of 15 or more, an average minor axis of 2 to 10 μm, and an average major axis of 30 to 250 μm, in an amount of 5 to 25% by mass with respect to the solid content of the slurry for joining,
a fine aggregate having an aspect ratio of 5 or less and an average diameter of 10 μm or less, in an amount of 40 to 60% by mass with respect to the solid content of the slurry for joining,
a coarse aggregate having an aspect ratio of 5 or less and an average diameter of 30 μm or more, in an amount of 5 to 15% by mass with respect to the solid content of the slurry for joining, and
a pore-forming agent having an average diameter of 30 to 120 μm, in an amount of 1 to 7% by mass with respect to the solid content of the slurry for joining.

By using an anisotropic inorganic powder having an aspect ratio of 15 or more, an average minor axis of 2 to 10 μm, and an average major axis of 30 to 250 μm, there is an advantage that the difference between the flexural strain at flexural strength and the flexural strain at break is large, and the compressive Young's modulus is small. In one embodiment, the shape of each particle constituting such anisotropic inorganic powder is fibrous and/or plate-like.

The aspect ratio of the anisotropic inorganic powder is preferably 15 or more, and more preferably 30 or more. By using anisotropic inorganic powder with a high aspect ratio in combination with aggregate with a low aspect ratio, there is an advantage the difference between flexural strain at flexural strength and flexural strain at break is further increased, and the compressive Young's modulus is further reduced. On the other hand, from the viewpoint of handling in the joining step, the aspect ratio of the anisotropic inorganic powder is preferably 150 or less, more preferably 100 or less, and even more preferably 80 or less. Therefore, the aspect ratio of the anisotropic inorganic powder is, for example, preferably 15 to 150, more preferably 30 to 100, and even more preferably 30 to 80.

As the content of anisotropic inorganic powder Is higher, the difference between the flexural strain at flexural strength and the flexural strain at break tends to be larger, but if it is excessive, the strength will decrease. Therefore, the content of the anisotropic inorganic powder having an aspect ratio of 15 or more, an average minor axis of 2 to 10 μm, and an average major axis of 30 to 250 μm is preferably 5 to 25% by mass, more preferably 5 to 20% by mass, and even more preferably 9 to 16% by mass, with respect to the solid content of the slurry for joining.

The anisotropic inorganic powder preferably comprises ceramic fibers having an aspect ratio of 15 or more, an average minor axis of 2 to 10 μm, and an average major axis of 100 to 250 μm, and more preferably comprises ceramic fibers having an aspect ratio of 15 to 100, an average minor axis of 2 to 10 μm, and an average major axis of 100 to 250 μm. The content of the ceramic fiber is preferably 5 to 25% by mass, and more preferably 10 to 20% by mass, with respect to the solid content of the slurry for joining.

Regarding the aggregate, use of two types, that is, a fine aggregate with an aspect ratio of 5 or less and an average diameter of 10 μm or less, and a coarse aggregate with an aspect ratio of 5 or less and an average diameter of 30 μm or more, is advantageous in that it makes it easier to increase the difference between the flexural strain at flexural strength and the flexural strain at break. The average diameter of the fine aggregate is preferably 2 to 6 μm, and more preferably 3 to 5 μm. The average diameter of the coarse aggregate is preferably 30 to 100 μm, and more preferably 40 to 70 μm. In addition, the average diameter of the fine aggregate and the coarse aggregate also affects the porosity. The larger the average diameter of the fine aggregates and the coarse aggregate is, the lower the porosity tends to be, and the smaller the average diameter of the fine aggregates and the coarse aggregate is, the higher the porosity tends to be.

As the ratio of the average diameter of the coarse aggregate to the average diameter of the fine aggregate is larger, the difference between the flexural strain at flexural strength and the flexural strain at break tends to be larger, but on the other hand, if the ratio is too large, the strength decreases. Therefore, the ratio is preferably in the range of 10 to 100, more preferably in the range of 20 to 60, and even more preferably in the range of 20 to 40.

As the mass ratio of the fine aggregate to the coarse aggregate is smaller, the difference between the flexural strain at flexural strength and the flexural strain at break tends to be larger, but on the other hand, if the ratio is too biased to one side, the difference becomes smaller. Therefore, the ratio preferably satisfies 4 to 10, more preferably 4 to 8, and even more preferably 4 to 6.

The aspect ratio of the fine aggregate is preferably (1 or more and) 5 or less, more preferably 3.5 or less, and even more preferably 2 or less. From the viewpoint that the difference between the flexural strain at flexural strength and the flexural strain at break is likely to increase, the content of fine aggregate having an aspect ratio of 5 or less and an average diameter of 10 μm or less is preferably 40 to 60% by mass, more preferably 43 to 57% by mass, and even more preferably 45 to 55% by mass, with respect to the solid content of the slurry for joining.

From the viewpoint of ensuring strength, the aspect ratio of the coarse aggregate is preferably (1 or more and) 5 or less, more preferably 3.5 or less, and even more preferably 2 or less. From the viewpoint that the difference between the flexural strain at flexural strength and the flexural strain at break is likely to increase, the content of coarse aggregate having an aspect ratio of 5 or less and an average diameter of 30 μm or more is preferably 5 to 15% by mass, more preferably 7.5 to 12.5% by mass, and even more preferably 10 to 12.5% by mass, with respect to the solid content of the slurry for joining.

By setting the average diameter of the pore-forming agent to 30 to 120 μm, an advantage is obtained in that the difference between the flexural strain at flexural strength and the flexural strain at break is easily increased. The higher the content of the pore-forming agent is, the higher the porosity can be, and conversely, the smaller the content of the pore-forming agent is, the lower the porosity can be. The content of the pore-forming agent having an average diameter of 30 to 120 μm is preferably 1 to 7% by mass, more preferably 3 to 6% by mass, and even more preferably 4 to 6% by mass, with respect to the solid content of the slurry for joining. The average diameter of the pore-forming agent is preferably 40 to 100 μm, and more preferably 50 to 80 μm.

In addition, regarding the pore-forming agent, use of two types, that is, a fine pore-forming agent with an average diameter of 50 μm or less and a coarse pore-forming agent with an average diameter of 80 μm or more, with an overall average diameter of 30 to 120 μm, is advantageous in that the difference between the flexural strain at flexural strength and the flexural strain at break is likely to increase. The average diameter of the fine pore-forming agent is preferably 20 to 50 μm, and more preferably 30 to 40 μm. The average diameter of the coarse pore-forming agent is preferably 80 to 120 μm, and more preferably 100 to 120 μm. In addition, as the average diameter of the pore-forming agent increases, the porosity tends to increase, and as the average diameter of the pore-forming agent decreases, the effect of increasing the porosity tends to decrease even with the same amount of pore-forming agent.

The aspect ratios of the anisotropic inorganic powder, the fine aggregate and the coarse aggregate are each measured by the following procedure. 100 random particles in the anisotropic inorganic powder, the fine aggregate, or the coarse aggregate to be measured are observed under a scanning electron microscope (SEM). Then, for each particle on the SEM image, the maximum Feret diameter dₘₐₓ and the minimum Feret diameter dₘᵢₙ are measured, and the aspect ratio AR=dₘₐₓ/dₘᵢₙ of the particle is calculated. The average aspect ratio of the 100 particles is defined as the measured value.

The average minor axis of the anisotropic inorganic powder is measured by the following procedure. 100 random particles in the anisotropic inorganic powder to be measured are observed under a scanning electron microscope (SEM). Then, the minimum Feret diameter dₘᵢₙ is measured for each particle on the SEM image, and the average value of the minimum Feret diameters dₘᵢₙ of the 100 particles is defined as the average minor axis.

The average major axis of the anisotropic inorganic powder is measured by the following procedure. 100 random particles in the anisotropic inorganic powder to be measured are observed under a scanning electron microscope (SEM). Then, the maximum Feret diameter dₘₐₓ is determined for each particle on the SEM image, and the average value of the minimum Feret diameters dₘₐₓ of the 100 particles is defined as the average major axis.

The average diameters of the fine aggregate, the coarse aggregate and the pore-forming agent are measured by the following procedure. 100 random particles in the fine aggregate, the coarse aggregate or the pore-forming agent to be measured are observed under a scanning electron microscope (SEM). Then, the circle-equivalent diameter of each particle on the SEM image is determined, and the average of the circle-equivalent diameters of the 100 particles is defined as the average diameter. It should be noted that some pore-forming agents expand, such as foamed resins and water-absorbent resins, but the average diameter of the pore-forming agent referred to here is a measurement value before the pore-forming agent expands.

As the material for the anisotropic inorganic powder, natural minerals or artificial ceramic fibers may be used. As the natural minerals, those having needle or plate shapes, such as volastonite, mica, talc, sepiolite, palygorskite, and attapulgite can be mentioned as suitable examples. In addition, as the artificial ceramic fibers, RCF (amorphous refractory ceramic fiber composed mainly of alumina and silica), alumina fiber, mullite fiber, carbon fiber, silicon carbide fiber, boron nitride fiber, potassium titanate fiber, and zinc oxide fiber can be mentioned as suitable ceramic fibers. As the anisotropic inorganic powder, one type may be used alone, or two or more types may be used in combination.

As the material of the aggregate, mention can be made to ceramics such as cordierite, mullite, zirconium phosphate, aluminum titanate, alumina silicate, silicon carbide, silicon-silicon carbide composites (for example, Si-bonded SiC), cordierite-silicon carbide composites, zirconia, spinel, indialite, sapphirine, corundum, titania, silicon nitride, and the like. It is preferable that the fine aggregate comprise one or more selected from silicon carbide, silicon-silicon carbide composites (for example, Si-bonded SiC), corundum, titania, and silicon nitride, and the coarse aggregate comprise one or more selected from cordierite, mullite, zirconium phosphate, aluminum titanate, alumina silicate, silicon carbide, silicon-silicon carbide composites (for example, Si-bonded SiC), cordierite-silicon carbide composites, zirconia, spinel, indialite, sapphirine, and corundum. It is more preferable that the fine aggregate comprise silicon carbide and the coarse aggregate comprise cordierite.

As the binder, either an inorganic binder or an organic binder may be used. As the organic binder, mention can be made to methyl cellulose, hydroxypropoxyl methyl cellulose, carboxymethyl cellulose, polyvinyl alcohol, and methyl cellulose. As the inorganic binder, mention can be made to clay minerals such as bentonite, montmorillonite, sepiolite, and attapulgite. As the binder, one type may be used alone, or two or more types may be used in combination.

The inorganic binder has a finer particle size than the fine aggregate and the coarse aggregate, and generally has an average diameter of 1 μm or less. The average diameter of the inorganic binder is measured by the following procedure. 100 random particles of the inorganic binder to be measured are observed under a scanning electron microscope (SEM). Then, the circle-equivalent diameter of each particle on the SEM image is determined, and the average of the circle-equivalent diameters of 100 particles is defined as the average diameter.

The slurry for joining may further comprise a dispersant such as polyethylene glycol oleate.

As the pore-forming agent, mention can be made to organic substances such as hollow or solid organic balloons like foamed resin, water-absorbent resins and starch, and inorganic substances such as fly ash balloons.

If the solid content concentration of the slurry for joining is too low, the joining width becomes thin, whereas if it is too high, the joining width becomes thick. Therefore, the solid content concentration of the slurry for joining is, for example, preferably 50 to 90% by mass, more preferably 60 to 80% by mass, and even more preferably 65 to 75% by mass.

For the segment joint body prepared by the above procedure, the outer periphery of may be ground to a desired shape (for example, cylindrical shape), and a coating material may be applied to the outer periphery side surface, followed by drying and heat treatment to form an outer periphery wall. The drying and heat treatment can be carried out under conditions of heating in an air atmosphere at 400 to 700° C., preferably 500 to 600° C., for 0.5 to 3 hours, preferably 0.5 to 1 hour. The coating material is not particularly limited, and any known outer periphery coating material can be used. As the outer periphery coating material, mention can be made to a slurry-like material made by adding water and additives such as organic binders, foaming resins, and dispersants to inorganic raw materials such as inorganic fibers, colloidal silica, clay, and ceramic particles. In addition, the method for applying the outer periphery coating material is not particularly limited, and any known method can be used.

The filter may carry a suitable catalyst depending on the application. As a method for carrying a catalyst on a filter, for example, mention can be made to a method in which a catalyst slurry is introduced into cells by a conventionally known suction method or the like, and the catalyst is caused to adhere to the surfaces and pores of the partition walls, and then high-temperature treatment is performed to bake the catalyst contained in the catalyst slurry onto the partition walls.

Examples of the catalyst include, but are not limited to, oxidation catalysts (DOCs) for increasing the exhaust gas temperature by oxidizing and burning hydrocarbons (HC) and carbon monoxide (CO), PM combustion catalysts for assisting in the combustion of PM such as soot, SCR catalysts and NSR catalysts for removing nitrogen oxides (NOx), and three-way catalysts capable of simultaneously removing hydrocarbons (HC), carbon monoxide (CO), and nitrogen oxides (NOx). The catalyst may appropriately contain, for example, precious metals (Pt, Pd, Rh, and the like), alkali metals (Li, Na, K, Cs, and the like), alkaline earth metals (Ca, Ba, Sr, and the like), rare earths (Ce, Sm, Gd, Nd, Y, La, Pr, and the like), transition metals (Mn, Fe, Co, Ni, Cu, Zn, Sc, Ti, Zr, V, Cr, and the like), and the like.

In particular, in DPFs for passenger vehicles, in order to simultaneously perform the functions of soot trapping and NOx purification, SCR catalysts such as Cu-substituted zeolite and Fe-substituted zeolite are supported on the DPF. In this case, NOx purification can be performed using ammonia obtained by decomposing urea on the vehicle.

### EXAMPLES

Hereinafter, the following examples are provided to better understand the present invention and its advantages, but the present invention is not limited to these examples.

### Examples 1 to 8 and Comparative Examples 1 to 9

### (1. Preparation of Honeycomb Structure Segments)

SiC powder and metal Si powder were mixed in a mass ratio of SiC powder:metal Si powder=80:20, and a pore-forming agent, an organic binder, a surfactant and water were added to the mixture to obtain a plastic green body. This green body was extrusion molded through a specified die and dried to obtain a pillar-shaped honeycomb formed body having an outer peripheral side wall and partition walls that partition a plurality of cells extending from a first end surface to a second end surface. In the pillar-shaped honeycomb formed body, sealing portions were formed at one end of each cell in such a manner that both end faces present a checkered pattern. That is, sealing portions were formed such that adjacent cells were sealed at the ends opposite to each other. The sealing portions were made of the same material as that of the pillar-shaped honeycomb formed body. After forming the sealing portions in this manner and drying, the pillar-shaped honeycomb formed body was degreased at approximately 400° C. in the air atmosphere and further fired at approximately 1450° C. in the Ar atmosphere to bond the SiC particles in the formed body with Si, thereby obtaining a rectangular parallelepiped honeycomb structure segment with the following specifications.

External shape: rectangular parallelepiped with a square end surface with sides of 36.2 mm and a height (length in the direction in which the cells extend) of 177.8 mm
Partition wall porosity: 42%
Average pore size of partition walls: 11 μm
Average thickness of partition walls: 0.305 mm
Cell cross-sectional shape: square
Cell density: 47 cells/cm² (300 cells/square inch)
Average thickness of outer side walls: 0.5 mm

### (2. Preparation of Slurry for Joining)

Next, anisotropic inorganic powder, aggregate (fine aggregate, coarse aggregate), and pore forming agent (fine pore forming agent, coarse pore forming agent) were added under the conditions of material, particle size, aspect ratio, content, and the like shown in Tables 1 to 3 according to the test number. Further, an organic binder (carboxymethyl cellulose), an inorganic binder (bentonite) and water were added, and the mixture was kneaded for 30 minutes using a mixer to obtain a slurry for joining (solid content concentration=73% by mass). The contents shown in Tables 1 to 3 are values relative to the solid content (100% by mass) of the slurry for joining.

The average major axis, average minor axis and aspect ratio of the anisotropic inorganic powder were measured by SEM observation according to the methods described above.

The average diameter and aspect ratio of the fine aggregate and the coarse aggregate were measured by SEM observation according to the method described above. The aspect ratios of the fine aggregate and the coarse aggregate are not shown in the table, but they were both about 1 to 3.

The average diameters of the fine pore-forming agent and the coarse pore-forming agent were measured by SEM observation according to the method described above.

### (3. Manufacture of Filter)

A process of applying the slurry for joining to the outer peripheral side surface of the honeycomb structure segment to a thickness of approximately 1 mm, and placing another honeycomb structure segment prepared in the same manner as described above on it was repeated to prepare a segment stack body consisting of a total of 16 honeycomb structure segments combined in four rows and four columns. Then, after the entire body was joined by applying an appropriate pressure from the outside, it was dried at 120° C. for 2 hours to obtain a segment joint body. The outer periphery of this segment joint body was ground such that the outer shape was cylindrical, and then a coating material of the same composition as the slurry for joining was applied to the ground surface to reform the outer periphery wall, then it was dried and hardened in the air atmosphere at 600° C. for 2 hours to obtain the filter (143.8 mmφ×177.8 mmL) of each test number. In the obtained filter, the side surfaces of a plurality of honeycomb structure segments were joined together via the joining material. The thickness of the joining material was about 1.1 mm. The filters were manufactured in the number required to carry out the following evaluation tests.

TABLE 1
Anisotropic inorganic powder

| | | Average | Average | | Content |
|---|---|---|---|---|---|
| | | major | minor | Aspect | [% by |
| Test No. | Material | axis [um] | axis [um] | ratio | mass] |
| Example 1 | RCF | 200 | 2.5 | 80 | 20 |
| Example 2 | RCF | 250 | 2.5 | 100 | 10 |
| Example 3 | Mulite fiber | 150 | 5 | 30 | 10 |
| Example 4 | Mulite fiber | 150 | 5 | 30 | 15 |
| Example 5 | Mulite fiber | 150 | 5 | 30 | 15 |
| Example 6 | Mulite fiber | 100 | 5 | 20 | 15 |
| Example 7 | Mulite fiber | 100 | 5 | 20 | 5 |
| Example 8 | Volastonite | 150 | 10 | 15 | 25 |
| | (needle-shaped) | | | | |
| Example 9 | Mica (plate-shaped) | 30 | 2 | 15 | 20 |
| Comparative | RCF | 200 | 2.5 | 80 | 20 |
| Example 1 | | | | | |
| Comparative | RCF | 200 | 2.5 | 80 | 20 |
| Example 2 | | | | | |
| Comparative | RCF | 200 | 2.5 | 80 | 20 |
| Example 3 | | | | | |
| Comparative | RCF | 200 | 2.5 | 80 | 40 |
| Example 4 | | | | | |
| Comparative | Mulite fiber | 150 | 5 | 30 | 15 |
| Example 5 | | | | | |
| Comparative | Mulite fiber | 150 | 5 | 30 | 15 |
| Example 6 | | | | | |
| Comparative | Mulite fiber | 150 | 5 | 30 | 3 |
| Example 7 | | | | | |
| Comparative | Mulite fiber | 70 | 5 | 14 | 10 |
| Example 8 | | | | | |
| Comparative | Mulite fiber | 300 | 5 | 60 | 15 |
| Example 9 | | | | | |

TABLE 2

| | Fine aggregate | | | Coarse aggregate | | | | |
|---|---|---|---|---|---|---|---|---|
| | | Average | Content | | Average | Content | Fine/coarse | Coarse/fine |
| | | diameter | [% by | | diameter | [% by | particle mass | particle size |
| Test No. | Material | [μm] | mass] | Material | [μm] | mass] | ratio | ratio |
| Example 1 | SiC | 3 | 40 | Cordierite | 40 | 10 | 4.0 | 13.3 |
| Example 2 | SiC | 3 | 50 | Alumina | 100 | 10 | 5.0 | 33.3 |
| | | | | silicate | | | | |
| Example 3 | SiC | 3 | 49 | Cordierite | 40 | 7 | 7.0 | 13.3 |
| Example 4 | SiC | 2 | 50 | Cordierite | 40 | 12.5 | 4.0 | 20.0 |
| Example 5 | SiC | 2 | 50 | Cordierite | 70 | 12.5 | 4.0 | 35.0 |
| Example 6 | SiC | 3 | 60 | Cordierite | 40 | 10 | 6.0 | 13.3 |
| Example 7 | SiC | 6 | 50 | Cordierite | 70 | 5 | 10.0 | 11.7 |
| Example 8 | SiC | 5 | 50 | Cordierite | 100 | 12.5 | 4.0 | 20.0 |
| Example 9 | SiC | 3 | 50 | Cordierite | 30 | 10 | 5.0 | 10.0 |
| Comparative | SiC | 15 | 40 | Cordierite | 25 | 20 | 2.0 | 1.7 |
| Example 1 | | | | | | | | |
| Comparative | SiC | 5 | 50 | Alumina | 10 | 12.5 | 4.0 | 2.0 |
| Example 2 | | | | silicate | | | | |
| Comparative | SiC | 3 | 50 | Cordierite | 40 | 2.5 | 20.0 | 13.3 |
| Example 3 | | | | | | | | |
| Comparative | SiC | 2 | 30 | Cordierite | 40 | 7.5 | 4.0 | 20.0 |
| Example 4 | | | | | | | | |
| Comparative | SiC | 3 | 30 | Cordierite | 40 | 30 | 1.0 | 13.3 |
| Example 5 | | | | | | | | |
| Comparative | SiC | 20 | 50 | Cordierite | 30 | 12.5 | 4.0 | 1.5 |
| Example 6 | | | | | | | | |
| Comparative | SiC | 3 | 70 | Cordierite | 40 | 17.5 | 4.0 | 13.3 |
| Example 7 | | | | | | | | |
| Comparative | SiC | 3 | 50 | Cordierite | 60 | 12.5 | 4.0 | 20.0 |
| Example 8 | | | | | | | | |
| Comparative | SiC | 3 | 48 | Cordierite | 10 | 8 | 6.0 | 3.3 |
| Example 9 | | | | | | | | |

TABLE 3

| | | Fine pore-forming agent | | Coarse pore-forming agent | |
|---|---|---|---|---|---|
| | Fine/coarse | Average | | Average | |
| | pore-forming | diameter | Content | diameter | Content |
| Test No. | agent | [um] | [% by mass] | [um] | [% by mass] |
| Example 1 | Foamed resin | 40 | 1 | - | - |
| Example 2 | Foamed resin | 40 | 1 | - | - |
| Example 3 | Foamed resin | 40 | 3 | 80 | 3 |
| Example 4 | Foamed resin | 40 | 3 | 120 | 3 |
| Example 5 | Foamed resin | 40 | 1 | 120 | 5 |
| Example 6 | Foamed resin | 40 | 3 | 120 | 4 |
| Example 7 | Foamed resin | 30 | 5 | 120 | 1 |
| Example 8 | Foamed resin | - | - | 120 | 6 |
| Example 9 | Foamed resin | 40 | 3 | 120 | 3 |
| Comparative | Foamed resin | 40 | 1 | | |
| Example 1 | | | | | |
| Comparative | Foamed resin | 40 | | - | - |
| Example 2 | | | | | |
| Comparative | Foamed resin | 30 | | - | |
| Example 3 | | | | | |
| Comparative | Foamed resin | 40 | | 120 | 2 |
| Example 4 | | | | | |
| Comparative | Foamed resin | 40 | | 120 | 2 |
| Example 5 | | | | | |
| Comparative | Foamed resin | 40 | | 120 | 1 |
| Example 6 | | | | | |
| Comparative | Foamed resin | 30 | 2 | 80 | 1 |
| Example 7 | | | | | |
| Comparative | Foamed resin | 40 | 2 | 120 | 3 |
| Example 8 | | | | | |
| Comparative | Foamed resin | 40 | 3 | 120 | |
| Example 9 | | | | | |

### (4. Evaluation Test)

For the filter of each test number, (a) the difference between the flexural strain at flexural strength of the joining material and the flexural strain at break (εfB-εfM), (b) the compressive Young's modulus of the joining material, (c) the shear strength between the side surface of the honeycomb structure segment and the joining material, and (d) the porosity of the joining material were measured according to the procedures described above. Further, for each filter, a rapid cooling test (electric furnace spalling (E-sp) test) and a Soot Mass Limit test (SML test) were carried out to evaluate the durability in an environment simulating that of an engine. The results are shown in Table 4.

### [Electric Furnace Spalling (E-Sp) Test]

The filter is heated in an electric furnace at a set temperature of 250° C. for 2 hours until the entire filter has a uniform temperature. After that, the filter is removed from the electric furnace and allowed to cool to room temperature for rapid cooling. After rapid cooling, the filter is visually inspected to see whether any cracks having a length of 3 mm or more have occurred. If no cracks are found, the filter is placed in the electric furnace with a set temperature 50° C. higher than before, heated and rapidly cooled again, and the presence or absence of any cracks is checked. This operation is repeated until any cracks are confirmed in the filter. The temperature at which any cracks are observed in the filter is taken as the measured temperature.

### [Soot Mass Limit Test (SML Test)]

The operation of depositing soot on the filter and regenerating it (burning the soot) is repeated while increasing the amount of soot deposited, and the amount of soot at which any cracks occurred is determined. Specifically, first, a non-thermally expandable mat of mullite composition fiber is wound around the outer periphery of the filter as a gripping material, and then the filter is pressed into a canning can made of stainless steel (SUS409) at a pressure in the range of 0.1 to 0.5 MPa to form a canned structure. Thereafter, soot-containing combustion gas generated by burning diesel fuel (light oil) with a burner is caused to flow into the cells from the first end surface of the filter and to flow out from the second end surface, thereby depositing 3 g/L of soot in the filter (the volume calculated by the mass of soot/the external dimensions of the filter). Then, the filter is once allowed to cool to room temperature. After that, the maximum temperature at a point 15 mm inward from the second end surface is measured when a high-temperature gas at 650° C. is introduced from the first end surface of the filter at a rate of 3 Nm³/min to combust the soot in the filter. Thereafter, the filter is again allowed to cool to room temperature, and visually checked whether or not any cracks having the length of 3 mm or more are observed in the filter. If no cracks are confirmed, the amount of soot deposited in the filter is increased by 0.5 to 1 g/L, the soot is burned again, the maximum temperature is measured, the filter is allowed to cool, and the presence or absence of any cracks is confirmed. As the amount of soot increases, the maximum temperature also increases. This operation is continued until any cracks are confirmed in the filter. The maximum temperature during the soot combustion when any cracks are observed in the filter is taken as the measured value.

TABLE 4

| | | Compressive | | | | |
|---|---|---|---|---|---|---|
| | | Young's | Shear | | Evaluation test | |
| | εfB − | Modulus | strength | Porosity | E-Sp | SML |
| Test No. | εfM | [MPa] | [kPa] | [%] | [° C.] | [° C.] |
| Example 1 | 0.004 | 20 | 1000 | 60 | 450 | 1300 |
| Example 2 | 0.002 | 35 | 800 | 60 | 400 | 1200 |
| Example 3 | 0.004 | 40 | 1000 | 65 | 450 | 1300 |
| Example 4 | 0.006 | 30 | 1100 | 68 | 450 | 1350 |
| Example 5 | 0.005 | 20 | 1000 | 70 | 450 | 1350 |
| Example 6 | 0.004 | 25 | 900 | 70 | 400 | 1250 |
| Example 7 | 0.002 | 50 | 600 | 70 | 350 | 1200 |
| Example 8 | 0.004 | 25 | 900 | 65 | 400 | 1250 |
| Example 9 | 0.004 | 40 | 900 | 65 | 350 | 1250 |
| Comparative | 0.001 | 80 | 1000 | 35 | 250 | 900 |
| Example 1 | | | | | | |
| Comparative | 0.001 | 150 | 1000 | 55 | 250 | 700 |
| Example 2 | | | | | | |
| Comparative | 0.001 | 40 | 1100 | 35 | 250 | 900 |
| Example 3 | | | | | | |
| Comparative | 0.008 | 30 | 1800 | 60 | 300 | 900 |
| Example 4 | | | | | | |
| Comparative | 0.001 | 60 | 500 | 60 | 200 | 800 |
| Example 5 | | | | | | |
| Comparative | 0.003 | 120 | 500 | 55 | 300 | 900 |
| Example 6 | | | | | | |
| Comparative | 0.001 | 150 | 1000 | 60 | 250 | 700 |
| Example 7 | | | | | | |
| Comparative | 0.001 | 120 | 600 | 65 | 300 | 900 |
| Example 8 | | | | | | |
| Comparative | 0.005 | 3 | 600 | 72 | 300 | 700 |
| Example 9 | | | | | | |

In Comparative Example 1, due to reasons such as inappropriate conditions of the aggregate used as the raw material of the joining material, the εfB-εfM of the joining material was too small, and excellent engine durability was not obtained.

In Comparative Example 2, the conditions of the aggregate used as the raw material of the joining material were inappropriate, so that the εfB-εfM of the joining material was too small and the compressive Young's modulus was too large, and therefore excellent engine durability was not obtained.

In Comparative Example 3, due to reasons such as inappropriate conditions of the aggregate used as the raw material of the joining material, the εfB-εfM of the joining material was too small, and excellent engine durability was not obtained.

In Comparative Example 4, the conditions of the anisotropic inorganic powder and aggregate used as the raw materials of the joining material were inappropriate, so that the εfB-εfM of the joining material became excessively large, and excellent engine durability was not obtained.

In Comparative Example 5, due to reasons such as inappropriate conditions of the aggregate used as the raw material of the joining material, the εfB-εfM of the joining material was too small, and excellent engine durability was not obtained.

In Comparative Example 6, due to reasons such as inappropriate conditions of the aggregate used as the raw material of the joining material, the compressive Young's modulus of the joining material was too large, and excellent engine durability was not obtained.

In Comparative Example 7, the conditions of the anisotropic inorganic powder and aggregate used as the raw materials of the joining material were inappropriate, so that the εfB-εfM of the joining material was too small and the compressive Young's modulus was too large, and therefore excellent engine durability was not obtained.

In Comparative Example 8, the conditions of the anisotropic inorganic powder used as the raw material of the joining material were inappropriate, so that the εfB-εfM of the joining material was too small and the compressive Young's modulus was too large, and therefore excellent engine durability was not obtained.

In Comparative Example 9, the compressive Young's modulus of the joining material was too small due to inappropriate conditions for the anisotropic inorganic powder used as the raw material of the joining material, and excellent engine durability was not obtained.

In contrast, in Examples 1 to 9, the conditions of the anisotropic inorganic powder and aggregate used as the raw materials of the joining material, and the conditions of the pore-forming agent were all appropriate, so that the εfB-εfM and the compressive Young's modulus of the joining material were within the desired range, and excellent engine durability was obtained. Among them, Examples 4 and 5 were able to obtain particularly excellent engine durability.

### DESCRIPTION OF REFERENCE NUMERALS

110: Filter
100: Pillar-shaped honeycomb structure segment
102: Side surface
103: Outer peripheral wall
104: First end surface
106: Second end surface
107: Joining material
108: First cell
110: Second cell
112: Partition wall
113: Outer peripheral side wall
120: Portion of pillar-shaped honeycomb structure segment
200: Test piece
300: Segment joint body

1. A filter in which side surfaces of a plurality of pillar-shaped honeycomb structure segments made of porous ceramics are joined together via a joining material,
wherein each of the pillar-shaped honeycomb structure segments comprises an outer peripheral side wall, and partition walls partitioning a plurality of cells extending from a first end surface to a second end surface; and
wherein the joining material is adjusted such that a difference between a flexural strain at flexural strength and a flexural strain at break, as measured by a four-point bending test in accordance with JIS K7017: 1999, as well as a compressive Young's modulus contribute to improving engine durability.

2. A filter in which side surfaces of a plurality of pillar-shaped honeycomb structure segments made of porous ceramics are joined together via a joining material,
wherein each of the pillar-shaped honeycomb structure segments comprises an outer peripheral side wall, and partition walls partitioning a plurality of cells extending from a first end surface to a second end surface; and
wherein the joining material has a difference between a flexural strain at flexural strength and a flexural strain at break of 0.002 to 0.007, as measured by a four-point bending test in accordance with JIS K7017: 1999, and a compressive Young's modulus of 5 to 100 MPa.

3. The filter according to claim 1, wherein the joining material has the difference between the flexural strain at flexural strength and the flexural strain at break of 0.0035 to 0.006, and the compressive Young's modulus of 20 to 60 MPa.

4. The filter according to claim 1, wherein a shear strength between the side surfaces of the plurality of pillar-shaped honeycomb structure segments and the joining material is 600 kPa or more.

5. The filter according to claim 1, wherein the joining material has a porosity of 40% or more.

6. The filter according to claim 1, wherein the joining material comprises silicon carbide.

7. The filter according to claim 1, wherein a length of the plurality of pillar-shaped honeycomb structure segments in a direction in which the cells extend is 178 mm or more.

8. The filter according to claim 1, wherein when a step of heating the filter in an electric furnace at a set temperature for 2 hours, removing the filter from the electric furnace, and allowing the filter to cool to room temperature, and then visually checking whether or not any cracks having a length of 3 mm or more are observed in the filter, is repeated under a condition that an initial temperature is set to 250° C. and the set temperature is increased by 50° C. each time until any cracks are observed, the set temperature at which any cracks are observed is 350° C. or higher.

9. The filter according to claim 1, wherein when the following steps 1 to 5 are performed, a maximum temperature in the step 3 when any cracks having a length of 3 mm or more are observed in the filter is 1000° C. or higher:
step 1: a non-thermally expandable mat of mullite fiber is wound around the outer periphery of the filter, and the filter is then pressed into a stainless steel can body at a pressure in a range of 0.1 to 0.5 MPa to form a canned structure, and a combustion gas containing soot generated by burning diesel fuel with a burner is then allowed to flow into the cells from the first end surface of the filter and to flow out from the second end surface, thereby depositing 3 g/L of soot in the filter;
step 2: after the step 1, the filter is allowed to cool to room temperature;
step 3: after the step 2, the maximum temperature at a point 15 mm inward from the second end surface is measured when a high-temperature gas of 650° C. is introduced from the first end surface of the filter at 3 Nm³/min to combust the soot in the filter;
step 4: after the step 3, the filter is again allowed to cool to room temperature, and visually checked whether or not any cracks having the length of 3 mm or more are observed;
step 5: if it is confirmed in the step 4 that no cracks are observed, steps 1 to 4 are repeated under a condition that an amount of soot deposited in the filter in the step 1 is increased by 0.5 to 1 g/L.

10. A method for manufacturing a filter, comprising:
a step 1 of preparing a plurality of pillar-shaped honeycomb structure segments made of porous ceramics, each comprising an outer peripheral side wall, and partition walls partitioning a plurality of cells extending from a first end surface to a second end surface; and
a step 2 of joining side surfaces of the plurality of pillar-shaped honeycomb structure segments made of porous ceramics together using a slurry for joining and then drying the slurry for joining;
wherein the slurry for joining comprises:
an anisotropic inorganic powder having an aspect ratio of 15 or more, an average minor axis of 2 to 10 μm, and an average major axis of 30 to 250 μm, in an amount of 5 to 25% by mass with respect to a solid content of the slurry for joining,
a fine aggregate having an aspect ratio of 5 or less and an average diameter of 10 μm or less, in an amount of 40 to 60% by mass with respect to the solid content of the slurry for joining,
a coarse aggregate having an aspect ratio of 5 or less and an average diameter of 30 μm or more, in an amount of 5 to 15% by mass with respect to the solid content of the slurry for joining, and
a pore-forming agent having an average diameter of 30 to 120 μm, in an amount of 1 to 7% by mass with respect to the solid content of the slurry for joining.

11. The method for manufacturing a filter according to claim 10, wherein a mass ratio of the fine aggregate to the coarse aggregate in the slurry for joining is 4 to 10.

12. The method for manufacturing a filter according to claim 10, wherein a ratio of the average diameter of the coarse aggregate to the average diameter of the fine aggregate in the slurry for joining is in a range of 10 to 100.

13. The method for manufacturing a filter according to claim 10, wherein each particle constituting the anisotropic inorganic powder has a fibrous and/or plate-like shape.

14. The method for manufacturing a filter according to claim 10, wherein the anisotropic inorganic powder comprises ceramic fibers having the aspect ratio of 15 or more, the average minor axis of 2 to 10 μm, and the average major axis of 100 to 250 μm.

15. The method for manufacturing a filter according to claim 14, wherein a content of the ceramic fibers is 5 to 25% by mass with respect to the solid content of the slurry for joining.

16. The method for manufacturing a filter according to claim 10, wherein the fine aggregate contains silicon carbide.

17. The method for manufacturing a filter according to claim 10, wherein the coarse aggregate comprises cordierite.
